(19) United States
(12) Patent Application Publication
(10) Pub. No.: US 2024/0386091 A1
(43) Pub. Date: Nov. 21, 2024

(54) EXECUTION OF PRIVILEGED OPERATIONS IN A CONTAINER

(71) Applicant: Siemens Aktiengesellschaft, München (DE)

(72) Inventor: Christian Knierim, München (DE)

(21) Appl. No.: 18/689,728

(22) PCT Filed: Sep. 1, 2022
(86) PCT No.: PCT/EP2022/074265

§ 371 Date: Mar. 6, 2024

(30) Foreign Application Priority Data
Sep. 13, 2021 (EP) 21196317.8

(51) Int. Cl. G06F 21/53; G06F 9/455; G06F 21/64

(52) U.S. Cl. CPC G06F 21/53; G06F 9/45558; G06F 21/64; G06F 2009/45562

(57) ABSTRACT

A method for executing privileged operations of an application program executed in a container on a host computer is provided, in which an extended execution permission to execute the container on a host computer is required in order to execute the privileged operation over non-privileged operations of the application program, including receiving a privilege policy monitoring called operations of the application program that are executed in the main container by way of a runtime environment of the host computer, launching a separate auxiliary container including the extended execution permission when a privileged operation contained in the privilege policy is called within the main container, executing the privileged operation in the auxiliary container on behalf of the main container, terminating the auxiliary container after the privileged operation has been executed, and continuing with the main container depending on feedback from the auxiliary container and/or the privilege policy.

### CROSS-REFERENCE TO RELATED APPLICATIONS

This application claims priority to PCT Application No. PCT/EP2022/074265, having a filing date of Sep. 1, 2022, which claims priority to European Application No. 21196317.8, having a filing date of Sep. 13, 2021, the entire contents both of which are hereby incorporated by reference.

### FIELD OF TECHNOLOGY

The following relates to methods for executing privileged operations of an application program executed in a container on a host computer, in which an extended access authorization for the container on the host computer is required for executing the privileged operation compared to non-privileged operations of the application program.

### BACKGROUND

Container virtualization is a method in which several instances of an operating system can use an operating system kernel of a host computer in isolation from each other. Software containers, referred to below as containers for short, therefore represent a lightweight type of virtualization of a runtime environment on a host computer, also known as a host system, and encapsulate an application operated in a container from the underlying host system.

Applications are now being implemented in many areas such as industrial automation and process control, but also for applications in transport systems or vehicles using containers.

In order to be able to start a container on the host system, a container image is required which also contains the binary programs and libraries required for the application software in addition to the application software, also known as the application program. A container, or more precisely a container instance, is created on the host system from the container image and executed on the runtime environment. If required, for example if the application is called more frequently by users, further container instances can be created and executed from the same container image on the same or a different host system. In the following, the container instance is referred to synonymously as a container.

Conventionally, container instances are operated using a runtime environment such as “Docker” on the host system, which may also be designed as virtualized hardware resources.

Containers or their processes are assigned execution privileges when the container instance is started. To avoid successful attacks from being carried out, these application execution rights can be minimized so that the container is only assigned the rights required to operate the application. Conventionally, read-only mounts are permitted to minimize execution rights, or a mandatory access control is set up for file systems. For containers that are based on a Linux operating system, processes operated in the container instance can also be assigned reduced execution privileges by the container runtime environment, for example by so-called “Capabilities” or “Seccomp” profiles.

If privileged operations or processes that include one or more privileged operations are to be executed at a dedicated point in time within the runtime of a container, the problem then arises that, once process privileges have been issued, they cannot simply be reassigned. If, for example, a software installation is to be carried out during the runtime of a container instance, the necessary operation requires the required rights from the outset, which means that the application cannot be optimally protected at runtime.

For example, container instances for different users are operated on the same cluster. A user thus works on their own container instance, which provides them with a stand-alone development environment in which, for example, program code is developed, and data is translated. In doing so, access rights within the container instance are minimized in order to prevent a user working on a container instance from breaking out of the container and thus being able to read or compromise the data of another user.

If, for example, a customer wants to install development tools in their instance at runtime, extended authorizations are required for this action that is rather rare and does not occur regularly compared to standard operation.

For privileged operations, it would be desirable in this case if the privileges required for this were not assigned permanently, but only temporarily and exclusively for the task to be performed. In this scenario, it should be possible to execute privileged operations again and again at non-regular intervals throughout the runtime of the container instance if required.

US 2005/071840 A1 discloses a method for handling privileged events using multiple virtual machine monitors (VMM) that run on a computer and represent an abstraction of one or more virtual machines (VM) to other software. A VM operates as a stand-alone platform that runs its own operating system, provided by a VMM, as well as other software, collectively referred to as host software. The host software thereby assumes that it is being executed on a stand-alone computer and, in particular, that it can control events and access hardware resources. If a privileged event is recognized, a VMM that is responsible for handling the event is selected. Information about the event and control of the event is transferred to the selected VMM.

US 2020/334371 A1 describes a method for identifying vulnerabilities of a virtualized execution instance that allows the execution instance to break out of its operating environment and execute operations on the operating system of the host system. For this purpose, a virtual execution instance is checked for privileged configurations before, during or after execution. If a privileged identifier is recognized during operation of the virtual instance, a control action is initiated.

US 2018/173885 A1 describes the basics of container virtualization and a method for secure communication between virtual computing instances such as containers, for example by providing a software-defined perimeter (SDP).

### SUMMARY

An aspect relates to creating a method in which execution privileges for executing privileged operations can be granted flexibly and for a limited time during the runtime of a container instance.

According to a first aspect, embodiments of the invention relate to a method for executing privileged operations of an application program executed in a container on a host computer, in which an extended execution authorization for the container on a host computer is required for executing the privileged operation compared to non-privileged operations of the application program, comprising:
receiving a privilege rule containing at least one privileged operation when starting a main container in a host computer,
monitoring called operations of the application program, which are executed in a main container, using a runtime environment of the host computer,
starting a separate secondary container comprising the extended execution authorization when a privileged operation contained in the privilege rule is called within the main container,
executing the privileged operation in the secondary container acting as a proxy for the main container,
ending the secondary container after executing the privileged operation, and
continuing the main container depending on confirmation from the secondary container and/or the privilege rule.

This makes it possible to run the main container in which the application program is executed with only non-extended execution authorization. This reduces the possibility of attacks on the host computer and other containers via the main container. By continuously monitoring the called operations, privileged operations can be recognized at any time during the entire execution time of the main container, and secondary containers can be started and thus execution programs with any number of privileged operations can be executed in a manner distributed over the execution time. Since the privileged operation is executed in the secondary container as a proxy for the main container, the non-extended execution authorization can be retained unchanged in the main container for the entire runtime of the main container. By ending the secondary container after the privileged operation has been executed, the possibility of an attack via the secondary container is limited to as short a time as possible. The main container can continue to be used flexibly thanks to the confirmation from the secondary container and the specifications in the rule.

In an embodiment, the privilege rule contains at least one transfer parameter of the privileged operation, and the secondary container is started depending on the at least one transfer parameter.

This means that privileged operations can be defined for one or more transfer parameters and thus the execution of the privileged operation can be restricted to these transfer parameters. This reduces the possibility of attacks on the host computer or other containers via the secondary container.

In an embodiment, the privilege rule for a privileged operation contains at least one of the following specifications:
at least one resource area of the host computer that can be accessed from both the main container and the secondary container, and/or
an extended execution authorization to be assigned to the secondary container, and/or
at least one operating option of a file system in the secondary container that differs from an operating option of the same file system that is assigned within the main container, and/or
a specification of a container image on which the secondary container is based, and/or
a redirection option for inputs and outputs, which causes inputs and outputs of the operations executed in the secondary container instance to be redirected to the main container, and the secondary container is executed depending on the at least one specification.

The specifications in the privilege rule allow the extended access authorizations to be set very flexibly for various privileged operations and thus optimized to actual requirements. In particular, the resource area is a Linux-specific namespace that is used to isolate resources, for example processes, memory areas or file systems or even networks of the containers on the host computer.

In an embodiment, the privilege rule contains a program to be executed in the secondary container instance, for example, with parameters of the program.

This makes it possible to specify and execute additional programs that are to be executed in connection with the privileged operation and with the same execution authorizations. This means that the privileged operations can also be extended flexibly and independently of the application program in the container.

In an embodiment, the privilege rule contains a processing mode specific to the privileged operation for the application program initiating the secondary container in the main container during execution of the secondary container.

This means that the processing of the application program in the main container can be defined specifically and therefore flexibly for the privileged operation by the privilege rule. Thus, several specific processing modes can specify the same processing mode for different privileged operations.

In an embodiment, the privilege rule is transferred to the host computer in a cryptographically protected manner.

A cryptographic signature of the privilege rule reduces the possibility of manipulation of the privilege rule and enables the creator of the rule to be verified. This results in different usage depending on the creator of the privilege rule.

In an embodiment, the results from the privileged operation executed in the secondary container are effective in the main container.

In an embodiment, the privilege rule is evaluated by a privilege control unit and the secondary container is started, executed and ended by the privilege control unit depending on the specifications of the privilege rule, wherein the privilege control unit is designed as an extension in the runtime environment of the host computer or in a stand-alone service on the operating system.

If the privilege control unit is designed as an extension of the container runtime environment, it is integrated by a corresponding main application during runtime. This type of design is known as a plug-in. The advantage of a plug-in design is that the runtime environment can notify the privilege control unit directly and can also provide meta information on the containers directly if necessary. However, the privilege control unit can also be formed in a stand-alone service on the operating system, for example a “daemon”. The stand-alone service is once again separated from the runtime environment. An attacker of the runtime environment therefore cannot compromise the privilege control unit if different non-privileged users are used for this purpose.

In an embodiment, the called operations of the application program are monitored by a process monitoring unit located in the runtime environment of the host computer, and the process monitoring unit is controlled by the privilege control unit.

In an embodiment, a resource-separated secondary container, which does not share a resource area with the main container for executing the privileged operation, is executed on a secondary host computer that is different from the host computer of the main container, depending on the privilege rule.

In contrast to a secondary container that shares resources, i.e. namespaces, with the main container, the resource-separated secondary container does not necessarily have to be executed on the same host computer and thus enables privileged operations to be executed in a complex host computer network. The resource-separated secondary container can also be executed on the same host computer as the main container. In particular, the secondary host computer can be secured.

In an embodiment, the privilege rule is provided to an orchestration unit, and the resource-separated secondary container is started by the orchestration unit.

This allows the main and secondary containers to be controlled by the orchestration unit and to be used in a complex orchestrated environment comprising several host computers and the orchestration unit.

In an embodiment, messages for controlling a resource-separated secondary container, which is executed on a secondary host computer different from the host computer of the main container, are exchanged between the privilege control unit on the host computer of the main container and the secondary host computer via the orchestration unit.

This means that no direct communication connection is required between the host computer of the main container and the secondary host computer. The orchestration unit can be integrated into the control of the secondary container and, depending on, for example, the utilization of the host computers, influence communication or influence the selection of the secondary host computer as well.

A further aspect of embodiments of the invention relates to a system for executing privileged operations of an application program executed in a container on a host computer, in which extended execution authorizations for the container on a host computer are required for executing the privileged operation compared to non-privileged operations of the application program, comprising a host computer as well as an optional orchestration unit, which are configured
to receive a privilege rule containing at least one privileged operation when starting a main container on the host computer,
to monitor called operations of the application program, which are executed in a main container, using a runtime environment of the host computer,
to start a separate secondary container containing the extended execution authorization when a privileged operation contained in the privilege rule is called within the main container,
to execute the privileged operation in the secondary container as a proxy for the main container,
to end the secondary container after execution of the privileged operation, and
to continue the main container depending on a confirmation from the secondary container and/or the privilege rule.

With the system according to embodiments of the invention, the at least one host computer or the containers executed on the system can be optimally protected against attacks, since extended execution authorizations are only granted temporarily for secondary containers. Extended execution authorizations can be granted to the secondary containers flexibly and in a manner specific to various privileged operations.

A further aspect of embodiments of the invention relates to a computer program product (non-transitory computer readable storage medium having instructions, which when executed by a processor, performs actions) comprising a non-volatile computer-readable medium which can be loaded directly into a memory of a digital computer, comprising pieces of program code which, when the pieces of program code are executed by the digital computer, cause the digital computer to perform the steps of the method.

Unless otherwise specified in the following description, the terms “receive”, “monitor”, “start”, “execute”, and the like, refer to actions and/or processes and/or processing steps that modify and/or generate data and/or convert the data into other data, wherein the data is or can be provided in particular as physical variables, for example as electrical pulses. The system and host computers and orchestration units and the like contained therein may comprise one or more processors.

A computer program product, such as a computer program resource, can be provided or delivered, for example, as a storage medium, such as a memory card, USB stick, CD-ROM, DVD or also in the form of a downloadable file from a server in a network. This can be done, for example, in a wireless communication network by transferring a corresponding file to the computer program product or the computer program resource.

### BRIEF DESCRIPTION

Some of the embodiments will be described in detail, with references to the following Figures, wherein like designations denote like members, wherein:

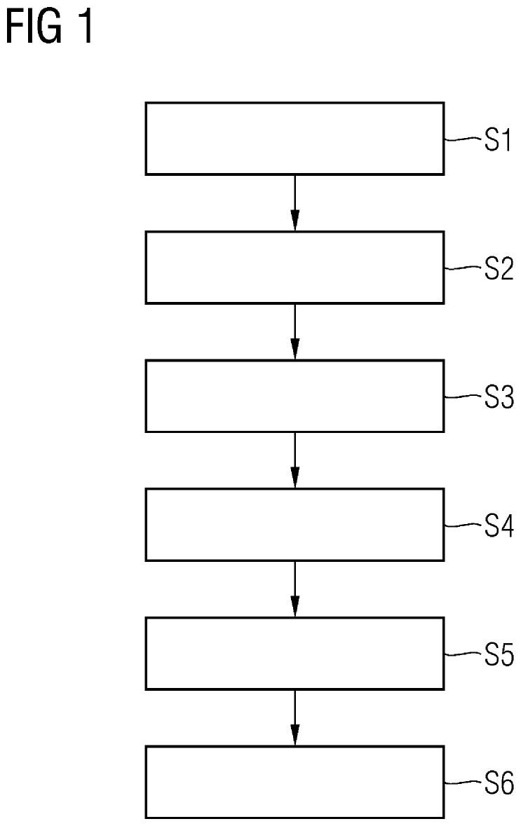

FIG. 1 shows an exemplary embodiment of the method as a flow chart;

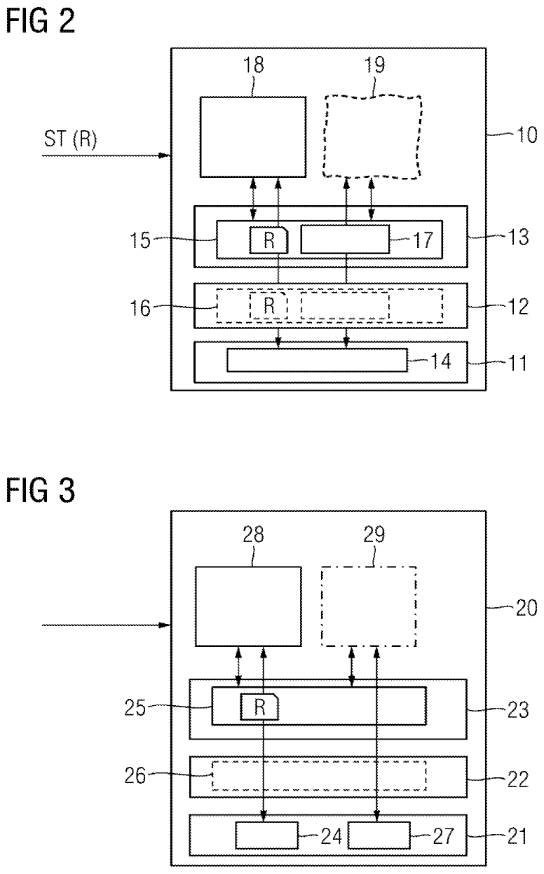

FIG. 2 shows a schematic representation of a first exemplary embodiment of the system with a host computer having a main container and a secondary container;

FIG. 3 shows a schematic representation of a second exemplary embodiment of the system with a host computer having a main container and a resource-separated secondary container; and

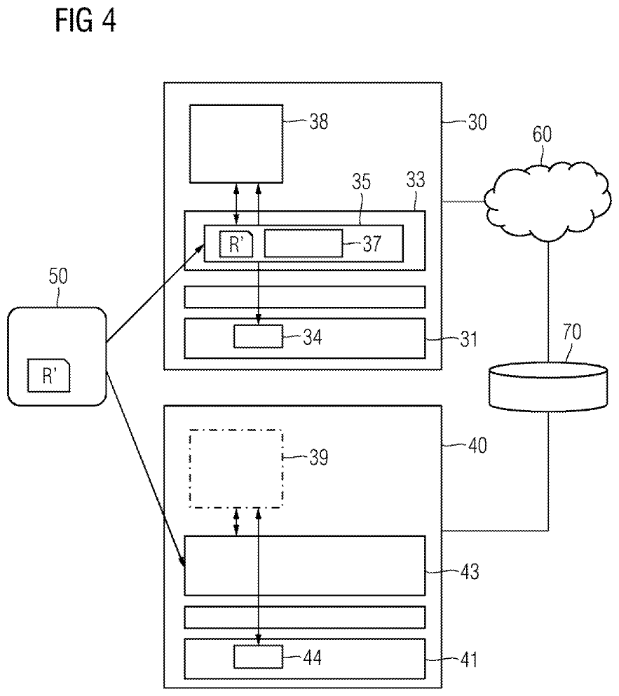

FIG. 4 shows a schematic representation of a third exemplary embodiment of the system with two host computers and an orchestration unit.

### DETAILED DESCRIPTION

To execute an application, or more precisely an application program, in a container-virtualized environment, the application program is executed in at least one container on a container runtime environment of a host computer. An application could, for example, be a development platform in which containers for different users are operated on a host computer or several host computers that together form a cluster. Each user thus works on their own container instance, which provides them with a stand-alone development environment in which program code is developed and data is translated. Execution rights within the container instance are thereby minimized in order to prevent a user working on a container instance from breaking out of the container instance and thus being able to read or compromise another user's data.

If a user wants to install development tools in their container instance at runtime, for example, extended authorizations are required for this action that is rather rare and does not occur regularly compared to standard operation.

To execute such an action, one or more privileged operations must be carried out that require an extended execution authorization in relation to non-privileged operations of the application program on the host computer. In order to minimize the execution rights of the container instance and still be able to execute the privileged operations, the following method is proposed and described below using FIG. 1.

For this purpose, a privilege rule containing the at least one privileged operation, with transfer parameters, is created and received in the host computer when a container instance, which is referred to below as the main container, is started, see method step S1. In method step S2, the operations of the application program subsequently called during the execution of the main container are monitored by the runtime environment of the host computer. If a privileged operation contained in the privilege rule is called within the main container, a separate secondary container with extended execution authorizations is started in accordance with the privilege rule, see method step S3. The secondary container is more privileged or not as restricted as the main container.

The privileged operation is then executed in the secondary container as a proxy for the main container, see method step S4. After execution of the privileged operation, the secondary container is ended, see method step S5, and the main container is continued depending on a confirmation from the secondary container and/or the privilege rule, see method step S6. In contrast to the application operated in the main container, the secondary container is not provided for the user or other services that use the functionality of the main container. It therefore only carries out an operation required for the main container as a proxy.

To illustrate the different hardware components involved, FIG. 2 shows a system configured to carry out the method.

The system comprises a host computer 10 with resources 11, for example at least one processor, a memory unit, network interfaces and the like. The host computer 10 comprises an operating system 12 that controls access to the resources 11 and on which a container runtime environment 13 is set up to control containers. Furthermore, the host computer 10 comprises at least one internal or external input and output interface, not explicitly shown, via which the privilege rule R and/or a container image on which the container is based and/or a request ST (R) to start the container can be received. The host computer 10 has a main container 18 and a secondary container 19, which comprises extended execution authorizations in relation to the main container 18 and executes the privileged operation as a proxy for the main container 18.

In addition to the privileged operations and their transfer parameters, the privilege rule R can also specify which resource areas 14 the main container 18 shares with the secondary container 19. For this purpose, the privilege rule R contains at least one resource area of the host computer that can be accessed from both the main container and the secondary container. The privilege rule R contains the extended execution authorization to be assigned to the secondary container 19, and at least one operating option of the file system in the secondary container 19, for example read-only access, which differs from an operating option of the same file system in the main container 18, for example write access. The privilege rule R can specify that inputs and outputs of the secondary container 19 are redirected to the main container 18 and that these are processed in the main container 18.

Furthermore, the privilege rule R may contain a specification on a container image on which the secondary container 19 is based. This makes it possible to specify whether the secondary container 19 is started with the same container image as the main container 18 but with extended execution authorizations, or whether it is started with a different container image. For example, as a standard configuration, the secondary container 19 is started with the same container image as the main container 18.

In addition to the privileged operation, a program to be executed can optionally be specified with program parameters in the privilege rule R. In this case, the program is executed in the secondary container 19 started for the operation with the extended execution privileges specified for the operation in the privilege rule R.

The privilege rule can contain a processing mode specific to the privileged operation for the application program in the main container 19 during execution of the secondary container 19. One processing mode can be that the actual application program that initiates the secondary container 19 is stopped during the execution of the secondary container 19. If necessary, the user can receive an input/output and a confirmation, also referred to as a return code, from the secondary container 19. The main container 18 then ends. A further processing mode specifies that the application program is stopped in the main container 18 and continued independently after execution of the secondary container 19. A further processing mode specifies that the application program in the main container 18 and the privileged operation in the secondary container 19 are executed in parallel.

In addition, the privilege rule R can be integrity-protected using a digital signature to protect against unauthorized changes.

The privilege rule R is evaluated by a privilege control unit 15. Furthermore, the privilege control unit 15 controls the starting, execution and ending of the secondary container 19 depending on the privilege rule R. The privilege control unit 15 is designed, for example, as an extension in the runtime environment 13 of the host computer 10 or in a stand-alone service 16 on the operating system 12 of the host computer 10. It is assumed that the container runtime environment 13 is trustworthy.

The called operations of the application program are monitored by a process monitoring unit 17. The process monitoring unit 17 is located in the runtime environment 13 of the host computer 10 and is controlled by the privilege control unit 15, 16. The process monitoring unit 17 comprises, for example, a kernel module developed for this purpose or a specific filter program such as an extended Berkley Packet Filter (eBPF) program. The privilege control unit 15, 16 parameterizes the kernel module or the eBPF interface in the process monitoring unit 17 for this purpose.

If an operation or process that is to be executed with privileges is recognized by the kernel module or an eBPF program, its execution in the main container is prevented by the privilege control unit 15, 16, if specified in the privilege rule R, or delayed if a program to be executed has been specified. The process thus remains inside the main container 18 in a waiting state. At the same time, the privilege control unit 15, 16 starts the secondary container 19 with the required privileges as specified in the rule and shares the defined shared resources 14, i.e. namespaces. If mount options, i.e. options for mounted file systems or memory areas, are to be changed, the mounts to be changed are mounted in a new mount namespace in accordance with the privilege rule R. The file system therefore remains in the main container 18, e.g. set to read-only, and can be mounted in the secondary container 19 for writing and can therefore be changed. The change operations are also visible in the main container after changes have been made.

Inputs and outputs of an application program executed in the secondary container 19 can be redirected to the process mounted in the main container 18 using the container runtime environment 13 and input/output redirects. This means that the user executing the application program can carry out operations as usual without realizing that the operation has been executed in a secondary container 19. The output can be redirected within the host computer, for example via a stream redirection of input/output channels. If the main and secondary containers are being executed on different host computers, a secure communication channel must first be set up in which the inputs/outputs are transferred from the secondary container. This is important so that the user is informed whether the command is executed successfully and—if program-specific inputs are required in the privileged secondary container—the user is given the option of executing these in the privileged container. Once the application program has been executed and the temporary secondary container 19 has ended, the program executed in the main container 18 is either also ended and reported back to the user with the return code of the temporary secondary container or—if specified in the rule—subsequently executed.

In one embodiment variant, no resource area, in particular no Linux namespaces, can be shared between the main container and the secondary container. A corresponding system with a corresponding main and secondary container is shown in FIG. 3. It comprises a host computer 20 which is constructed in the same way as the host computer 10 in FIG. 1. The secondary container that does not share any resource areas with the main container 28 is referred to as a resource-separated secondary container 29. Thus, a resource area 24 is assigned to the main container 28 and a resource area 27, which does not overlap with the resource area 24, is assigned to the resource-separated secondary container 29. The resource-separated secondary container 29 is triggered by an operation in the main container 28, which is specified in the privilege rule R.

When using resource-separated secondary containers 29, it is possible in an orchestrated environment that defined operations are executed, in a resource-separated secondary container on a secondary host computer that is different from the host computer of the main container, using an orchestration unit.

FIG. 4 shows a system with two host computers, the host computer 30, on which the main container 38 is executed, and a secondary host computer 40, on which the resource-separated secondary container 39 is executed. The main container 38 is assigned a resource area 34 from the resources 31 of the host computer 30, while the secondary container 39 is assigned a different resource area 44 from the resources 41 of the secondary host computer 40.

The system further comprises an orchestration unit 50 on which the privilege rule R′is arranged. The at least one operation to be executed on the resource-separated secondary container is specified using additional information within the privilege rule R′. The orchestration unit 50 transmits the privilege rule R′ or a subset thereof to the host computer 30. A privilege control unit 35 monitors the executed operations of the main container 38 depending on the privilege rule R′. The orchestration unit 50 transmits messages for controlling a resource-separated secondary container 39 between a privilege control unit 37 on the host computer 30 of the main container 38 and the secondary host computer 40.

The main container 38 is executed on the host computer 30, for example, which is connected to a data network 60, such as the Internet. The host computer 30 integrates a file system 70 that is available for all host computers 30, 40 in the system, but which may only be changed on special, protected host computers, in this case secondary host computers 40. Access to the secondary host computer 40 can, for example, only be enabled via a firewall component. The secondary host computer can also include software- or hardware-based protection mechanisms, such as tamper protection.

In this case, the privilege control unit 35 does not interact with the local container runtime environment 35 of the host computer 30, but with the orchestration unit 50. The orchestration unit 50 controls the creation and execution of the resource-separated secondary container 39, triggered by a privileged operation in the main container 38, on the secured secondary host computer 40. The execution of the initiating program in the main container 38 on the host computer 30 is delayed or prevented by the orchestration unit, for example. Via the orchestration unit 50 or via an orchestration interface, any inputs and outputs of the secondary container 39 are transferred to the main container 38.

With the method and system described, the main container does not require increased execution authorizations if privileged operations are to be carried out for the main container. Based on events within the main container, privileged operations can be carried out within a separate secondary container. Individual operations with corresponding parameters can be executed with privileges. Different secondary container instances can also be started for different parameterizations of the trigger operations within the main container. In principle, a privileged operation can also be used to start several secondary containers with different privileges. Different actions must then be stored for several parameters of an operation. For example, operation -a -b -c starts three secondary containers if different actions are stored for the parameters -a, -b and -c. In the extended, orchestrated variant, security-critical operations can be executed on specially secured host computers, for example by using node selectors.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for executing privileged operations of an application program executed in a container on a host computer, in which an extended execution authorization for the container on a host computer is required for executing the privileged operation compared to non-privileged operations of the application program, comprising:
receiving a privilege rule containing at least one privileged operation when starting a main container in a host computer;
monitoring called operations of the application program, which are executed in the main container, using a runtime environment of the host computer;
starting a separate secondary container comprising the extended execution authorization when a privileged operation contained in the privilege rule is called within the main container;
executing the privileged operation in the secondary container as a proxy for the main container;
ending the secondary container after execution of the privileged operation; and
continuing the main container depending on a confirmation from the secondary container and/or the privilege rule.

2. The method as claimed in claim 1, wherein the privilege rule contains at least one transfer parameter of the privileged operation and the secondary container(s) is started depending on the at least one transfer parameter.

3. The method as claimed in claim 1, wherein the privilege rule for a privileged operation contains at least one of the following specifications
at least one resource area of the host computer, which are accessed both from the main container and from the secondary container;
an extended execution authorization to be assigned to the secondary container;
at least one operating option of a file system in the secondary container, which differs from an operating option of the same file system assigned within the main container; and/or
a redirection option for inputs and outputs that causes inputs and outputs of the operations executed in the secondary container to be redirected to the main container; and
the secondary container is executed depending on the at least one specification.

4. The method as claimed in claim 1, wherein the privilege rule contains a specification of a container image on which the secondary container is based.

5. The method as claimed in claim 1, wherein the privilege rule contains a program to be executed in the secondary container, with parameters of the program.

6. The method as claimed in claim 1, wherein the privilege rule contains a processing mode specific to the privileged operation for the application program initiating the secondary container in the main container during execution of the secondary container.

7. The method as claimed in claim 1, wherein the privilege rule is transferred to the host computer in a cryptographically protected manner.

8. The method as claimed in claim 1, wherein results from the privileged operation executed in the secondary container are effective in the main container.

9. The method as claimed in claim 1, wherein the privilege rule is evaluated by a privilege control unit, and the secondary container is started, executed and ended by a privilege control unit depending on the privilege, wherein the privilege control unit is formed as an extension in the runtime environment of the host computer or in a stand-alone service on the operating system.

10. The method as claimed in claim 1, wherein the called operations of the application program are monitored by a process monitoring unit located in the runtime environment of the host computer and the process monitoring unit is controlled by the privilege control unit.

11. The method as claimed in claim 1, wherein a resource-separated secondary container, which does not share a resource area with the main container for executing the privileged operation, is executed on a secondary host computer different from the host computer of the main container, depending on the privilege rule.

12. The method as claimed in claim 11, wherein the privilege rule is provided to an orchestration unit, and the resource-separated secondary container is started by the orchestration unit.

13. The method as claimed in claim 8, wherein messages for controlling a resource-separated secondary container being executed on a secondary host computer different from the host computer of the main container are exchanged between the privilege control unit on the host computer of the main container and the secondary host computer via the orchestration unit.

14. A system for executing privileged operations of an application program executed in a container on a host computer, in which extended execution authorizations for the container on a host computer are required for executing the privileged operation compared to non-privileged operations of the application program, comprising at least one host computer as well as an optional orchestration unit, which are configured
to receive a privilege rule containing at least one privileged operation when starting a main container on the host computer;
to monitor called operations of the application program, which are executed in a main container, using a runtime environment of the host computer;
to start a separate secondary container comprising the extended execution authorization when a privileged operation contained in the privilege rule is called within the main container;
to execute the privileged operation in the secondary container as a proxy for the main container;
to end the secondary container after execution of the privileged operation; and
to continue the main container depending on a confirmation from the secondary container and/or the privilege rule.

15. A computer program product, comprising a non-volatile computer readable hardware storage device having computer readable program code stored therein, said program code executable by a processor of a computer system to implement a method wherein, the non-volatile computer-readable storage device which can be directly loaded into a memory of a digital computer, comprising pieces of program code which, when the pieces of program code are executed by the digital computer, cause the digital computer to perform the steps of the method as claimed in claim 1.
